(19) United States
(12) Patent Application Publication
(10) Pub. No.: US 2018/0204215 A1
(43) Pub. Date: Jul. 19, 2018

(54) DETECTING ELECTRONIC INTRUDERS VIA UPDATABLE DATA STRUCTURES

(71) Applicants: Hung-Tzaw Hu, Saratoga, CA (US); Haochuan Zhou, Redwood City, CA (US); Ge Wen, Fremont, CA (US); Benjamin Scott Boding, Mountain View, CA (US)

(72) Inventors: Hung-Tzaw Hu, Saratoga, CA (US); Haochuan Zhou, Redwood City, CA (US); Ge Wen, Fremont, CA (US); Benjamin Scott Boding, Mountain View, CA (US)

(21) Appl. No.: 15/408,236

(22) Filed: Jan. 17, 2017

(51) Int. Cl. G06Q 20/40; H04L 29/06

(52) U.S. Cl. CPC G06Q 20/401; H04L 63/10

(57) ABSTRACT

A data structure provides reliable data allowing a security application to detect potential instances of fraudulent use of a payment account. The data structure can be generated using data elements associated with transactions from new authentication requests in a transaction. Once the data structure is generated, clusters within the data structure can be associated with legitimate authentication requests or potentially fraudulent authentication requests. A baseline cluster can be identified from the data structure and used to determine whether the new incoming authentication requests are legitimate or potentially fraudulent.

### BACKGROUND

An unauthorized user may fraudulently request access to a resource using some information of an authorized user. To prevent unauthorized access, a resource security system may implement access rules to reject access requests having certain parameters that are indicative of a fraudulent attack. Generally, detection mechanisms are based on analysis of individual data elements of authentication requests, such as a name, secret identifier (e.g., as password), and device fingerprint. Conventional detection methods analyze these individual data elements to determine if new requests match an authorized user or compare data elements of a possible intruder to a blacklist.

Current detection systems are not entirely accurate and sometimes result in approving fraudulent requests. These detection systems are especially problematic during the period of time when fraudulent requests occur before an authorized user detects the attack. During this period of “infected time,” both the authorized and fraudulent actors may be initiating access requests. Some of the suspicious requests may be approved and result in fraudulent access. Further, an authorized user may be rejected even though the requests are legitimate. For example, when an authentic user gets new credentials, the user may continue to get access requests rejected due to the previous compromised activity.

Accordingly, there is a need for a detection mechanism that more accurately discriminates between fraudulent access requests and legitimate access requests during and after an attack on a resource involved in communications of access requests among networked devices.

### BRIEF SUMMARY

Embodiments of the invention provide systems, methods, and apparatuses for managing access to a protected resource, e.g., a protected computer. The access can be managed using a data structure that is generated from a plurality of requests associated with a resource identifier. The data structure can be generated by collecting and linking data elements from the plurality of requests over time. As a new request is received, a system can generate a data structure (or add to an existing data structure) linking the various data elements together as nodes. Once the data structure is generated, the data structure may be organized into clusters that represent legitimate or potentially fraudulent authentication requests. For example, a baseline cluster may be identified from the data structure that represents statistically reliable data on legitimate authentication requests. Pattern recognition techniques may be used to determine to what extent the data elements of the new authentication request match the nodes in the baseline cluster. By comparing the new authentication requests with the baseline cluster, a more reliable decision can be made regarding the legitimacy of new authentication requests.

According to one embodiment of the invention, a new authentication request can be received, where the new authentication request comprising a resource identifier and one or more current data elements. A data structure can be stored in a computer-readable medium that is accessible by a computer system, where the data structure is associated with the resource identifier and has existing nodes corresponding to existing data elements in previous authentication requests that includes the resource identifier. The data structure can have connections (bindings) indicating which existing nodes have occurred in a previous authentication request. The one or more current data elements in the new authentication request can be compared to the existing nodes in the data structure, where the existing nodes are stored in the data structure in one or more clusters based on a commonality of the connections among the existing nodes. In response to comparing the one or more current data elements in the new authentication request to the existing nodes in the data structure, one or more new data elements of the one or more current data elements that does not match one of the existing nodes of the data structure can be identified. The one or more new data elements can be added as additional nodes in the data structure. The additional nodes can be stored in an existing cluster responsive to a number of the one or more current data element matching existing nodes of the existing cluster, where the existing cluster represents a pattern of legitimate authentication requests. The additional nodes can also be stored in a new cluster in the data structure, where the new cluster in the data structure represents a pattern of potentially fraudulent authentication requests.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 shows a resource security system for authorizing access to resources, in accordance with some embodiments

FIG. 2 illustrates an example of a time-dependent chart illustrating a timeline of a compromised account according to embodiments of the present invention.

FIG. 3 shows an example of an initial data structure according to embodiments of the present invention.

FIG. 4 shows an example of an updated data structure according to embodiments of the present invention.

FIG. 5 shows a flowchart of a method for generating a data structure according to embodiments of the present invention.

FIG. 6 shows an exemplary data structure according to embodiments of the present invention.

FIG. 7 shows an example frequency plot of a data structure plotted in a time domain according to embodiments of the present invention.

FIG. 8 shows a table showing the performance data of the data structure from FIG. 6.

FIG. 9 shows another exemplary data structure according to embodiments of the present invention.

FIG. 10 shows an exemplary data structure for a first resource of an owner according to embodiments of the present invention.

FIG. 11 shows an exemplary data structure for a second resource of an owner according to embodiments of the present invention.

FIG. 12 shows a block diagram of an access server according to embodiments of the present invention.

### TERMS

Prior to discussing embodiments of the invention, description of some terms may be helpful in understanding embodiments of the invention.

The term “resource” generally refers to any asset that may be used or consumed. For example, the resource may be an electronic resource (e.g., stored data, received data, a computer account, a network-based account, an email inbox), a physical resource (e.g., a tangible object, a building, a safe, or a physical location), or other electronic communications between computers (e.g., a communication signal corresponding to an account for performing a transaction).

The term “access request” (also referred to as an “authentication request”) generally refers to a request to access a resource. The access request may be received from a requesting computer, a user device, or a resource computer, for example. The access request may include authentication information (also referred to as authorization information), such as a user name, resource identifier, or password. The access request may also include and access request parameters, such as an access request identifier, a resource identifier, a timestamp, a date, a device or computer identifier, a geo-location, or any other suitable information.

The term “access rule” may include any procedure or definition used to determine an access rule outcome for an access request based on certain criteria. In some embodiments, the rule may comprise one or more rule conditions and an associated rule outcome. A “rule condition” may specify a logical expression describing the circumstances under which the outcome is determined for the rule. A condition of the access rule may involve authentication information, as well as request parameters. For example, the authentication information can be required to sufficiently correspond to information categorized as legitimate, e.g., based on a match to critical nodes of a data structure and/or to a sufficient number of nodes. A condition can require a specific parameter value, a parameter value to be within a certain range, a parameter value being above or below a threshold, or any combination thereof.

The term “data structure” may include a set of data elements organized in a manner that specifies any relation the data elements have to each other. For example, a data structure can form a linked list or other type of array with certain data elements forming nodes that are each linked to one or more other nodes. Various types of linked lists can be formed, such as doubly linked lists, multiply linked lists (where one node is linked to multiple nodes), circular linked lists (where two nodes are directly linked to each other by being linked to a shared node), or multiply circular linked lists (wherein two nodes are each linked to two shared nodes). Such a data structure can form a hierarchal set of nodes.

The terms “binding” or “connection” can refer to two data elements being bound if (and potentially only if) the two elements are included in one access request together. The binding can be extended to more than two elements scenarios. All elements in one request can be bound together. A “cluster” of data elements (nodes) can refer to a collection of overlapped bindings or that overlap on certain data elements. The term “affiliation” can refer to at least two clusters being affiliated by overlapping on certain common nodes (not including a resource identifier). Strong affiliation and legitimate histories of access requests can merge two or more clusters into one larger cluster.

The term “server computer” may include a powerful computer or cluster of computers. For example, the server computer can be a large mainframe, a minicomputer cluster, or a group of computers functioning as a unit. In one example, the server computer may be a database server coupled to a web server. The server computer may be coupled to a database and may include any hardware, software, other logic, or combination of the preceding for servicing the requests from one or more other computers. The term “computer system” may generally refer to a system including one or more server computers coupled to one or more databases.

As used herein, the term “providing” may include sending, transmitting, making available on a web page, for downloading, through an application, displaying or rendering, or any other suitable method.

### DETAILED DESCRIPTION

Current fraud detection methods typically use blacklists of compromised resources or other data elements associated with fraudulent attacks on a resource. Such use of blacklists can prevent a legitimate user from access a resource, e.g., when the legitimate user is issued a new identifier for accessing a resource. Such a legitimate user may still be associated with previous data elements (e.g., an email) that can cause future access requests to be denied.

Embodiments of the invention can provide a data structure that allows discrimination of fraudulent requests while still allowing a legitimate user to continue to access one or more resources that are being protected by a resource security system. The data structure can be generated from a plurality of authentication requests that are associated with a resource identifier (e.g., a user account of a computer resource). The data structure can be generated using data elements associated with access requests, where the data elements form nodes within the data structure. Sets of nodes within the data structure can be identified as belonging to certain clusters, e.g., each corresponding to a different legitimate or fraudulent actor.

Authentication using a resource security system is first discussed, followed by a description of changes in compromised resource over time, and then data structures and uses thereof.

### I. AUTHENTICATION FOR ACCESSING A PROTECTED RESOURCE

Generally, access requests for a computer resource or account (e.g., transactions over the Internet) go through a fraud detection system to determine whether the transaction is authorized or rejected as being fraudulent. Thus, a resource security system may receive requests to access a resource. The resource security system may include an access server for determining an outcome for the access request based on access rules. An example resource security system is described in further detail below.

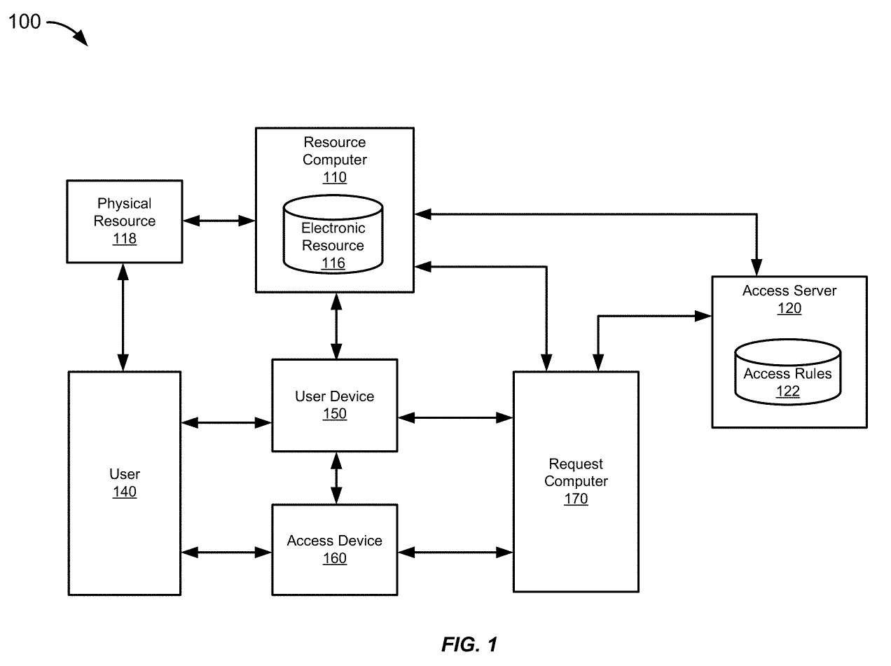

FIG. 1 shows a resource security system 100 for authorizing access to resources, in accordance with some embodiments. The resource security system 100 may be used to provide authorized users (e.g., via authentication) access to a resource while denying access to unauthorized users. In addition, the resource security system 100 may be used to deny fraudulent access requests that appear to be legitimate access requests of authorized users. The resource security system 100 may implement access rules to identify fraudulent access requests based on parameters of the access request. Such parameter may correspond to fields (nodes) of a data structure that is used to distinguish fraudulent access requests from authentic access requests.

The resource security system 100 includes a resource computer 110. The resource computer 110 may control access to a physical resource 118, such as a building or a lockbox, or an electronic resource 116, such as a local computer account, digital files or documents, a network database, an email inbox, a payment account, or a website login. In some embodiments, the resource computer may be a webserver, an email server, or a server of an account issuer. The resource computer 110 may receive an access request from a user 140 via a user device 150 (e.g., a computer or a mobile phone) of the user 140. The resource computer 110 may also receive the access request from the user 140 via a request computer 170 coupled with an access device 160 (e.g., a keypad or a terminal). In some embodiments, the request computer 170 may be a service provider that is different from the resource provider.

The access device 160 and the user device 150 may include a user input interface such as a keypad, a keyboard, a finger print reader, a retina scanner, any other type of biometric reader, a magnetic stripe reader, a chip card reader, a radio frequency identification reader, or a wireless or contactless communication interface, for example. The user 140 may input authentication information into the access device 160 or the user device 150 to access the resource. Authentication information may also be provided by the access device 160 and/or the user device 150. The authentication information may include, for example, one or more data elements of a user name, an account number, a token, a password, a personal identification number, a signature, a digital certificate, an email address, a phone number, a physical address, and a network address. The data elements may be labeled as corresponding to a particular field, e.g., that a particular data element is an email address. In response to receiving authentication information input by the user 140, the user device 150 or the request computer 170 may send an access request, including authentication information, to the resource computer 110 along with one or more parameters of the access request.

In one example, the user 140 may enter one or more of an account number, a personal identification number, and password into the access device 160, to request access to a physical resource (e.g., to open a locked security door in order to access a building or a lockbox) and the request computer 170 may generate and send an access request to the resource computer 110 to request access to the resource. In another example, the user 140 may operate the user device 150 to request that the resource computer 110 provide access to the electronic resource 116 (e.g., a website or a file) that is hosted by the resource computer 110. In another example, the user device 150 may send an access request (e.g., an email) to the resource computer 110 (e.g., an email server) in order to provide data to the electronic resource 116 (e.g., deliver the email to an inbox). In another example, the user 140 may provide an account number and/or a personal identification number to an access device 160 in order to request access to a resource (e.g., a payment account) for conducting a transaction.

In some embodiments, the resource computer 110 may verify the authentication information of the access request based on information stored at the request computer 170. In other embodiments, the request computer 170 may verify the authentication information of the access request based on information stored at the resource computer 110.

The resource computer 110 may receive the request substantially in real-time (e.g., account for delays computer processing and electronic communication). Once the access request is received, the resource computer 110 may determine parameters of the access request. In some embodiments, the parameters may be provided by the user device 150 or the request computer 170. For example, the parameters may include one or more of: a time that the access request was received, a day of the week that the access request was received, the source-location of the access request, the amount of resources requested, an identifier of the resource being request, an identifier of the user 140, the access device 160, the user device 150, the request computer 170, a location of the user 140, the access device 160, the user device 150, the request computer 170, an indication of when, where, or how the access request is received by the resource computer 110, an indication of when, where, or how the access request is sent by the user 140 or the user device 150, an indication of the requested use of the electronic resource 116 or the physical resource 118, and an indication of the type, status, amount, or form of the resource being requested. In other embodiments, the request computer 170 or the access server 120 may determine the parameters of the access request.

The resource computer 110 or the request computer 170 may send the parameters of the access request to the access server 120 in order to determine whether the access request is fraudulent. The access server 120 may store one or more access rules 122 for identifying a fraudulent access request. Each of the access rules 122 may include one or more conditions corresponding to one or more parameters of the access request. The access server 120 may determine an access request outcome indicating whether the access request should be accepted (e.g., access to the resource granted), rejected (e.g., access to the resource denied), or reviewed by comparing the access rules 122 to the parameters of the access request as further described below. In some embodiments, instead of determining an access request outcome, the access server 120 may determine an evaluation score based on outcomes of the access rules. The evaluation score may indicate the risk or likelihood of the access require being fraudulent. If the evaluation score indicates that the access request is likely to be fraudulent, then the access server 120 may reject the access request.

The access server 120 may send the indication of the access request outcome to the resource computer 110 (e.g., accept, reject, review, accept and review, or reject and review). In some embodiments, the access server 120 may send the evaluation score to the resource computer 110 instead. The resource computer 110 may then grant or deny access to the resource based on the indication of the access request outcome or based on the evaluation score. The resource computer 110 may also initiate a review process for the access request.

In some embodiments, the access server 120 may be remotely accessed by an administrator for configuration. The access server 120 may store data in a secure environment and implement user privileges and user role management for accessing different types of stored data. For example, user privileges may be set to enable users to perform one or more of the following operations: view logs of received access request, view logs of access request outcomes, enable or disable the execution of the access rules 122, update or modify the access rules 122, change certain access request outcomes. Different privileges may be set for different users.

The resource computer 110 may store access request information for each access requests that it receives. The access request information may include authentication information and/or the parameters of each of the access requests. The access request information may also include an indication of the access request outcome for the access request, e.g., whether access request was actually fraudulent or not. The resource computer 110 may also store validity information corresponding to each access request. The validity information for an access request may be initially based on its access request outcome. The validity information may be updated based on whether the access request is reported to be fraudulent. In some embodiments, the access server 120 or the request computer 170 may store the access request information and the validity information.

### II. TIME-DEPENDENT CHANGES IN A COMPROMISED RESOURCE

Embodiments can address issues with resources that become compromised and the issuance of new resources to a user while preventing the user from improperly being denied access to a newly issued resource. For example, if a legitimate user is issued a new email, login, or new account number, embodiments can be used to manage a fraud detection system so that the legitimate user does not get blocked as a result of being associated with the compromised resource.

A compromised resource may have different states over time. For example, a resource may have three time zones: a prior time zone, an infected time zone, and a post time zone. During the prior time zone, a user may initiate legitimate access requests and gain authorized access to a resource. However, the resource may become compromised by an intruder. During this next time period (e.g., “infected time zone”), the account is infected and both the user and the intruder may be initiating requests on the compromised account. Some of the suspicious requests may be approved and result in improper access by the intruder, thereby costing loss of privacy or money. In addition, some of the user's requests may be rejected even though the requests are legitimate. When the user informs a provider of the resource (e.g., to cancel an account), a new resource may be issued, e.g., a new account issued). However, during this third time period (e.g., “post time zone”), several issues may still arise.

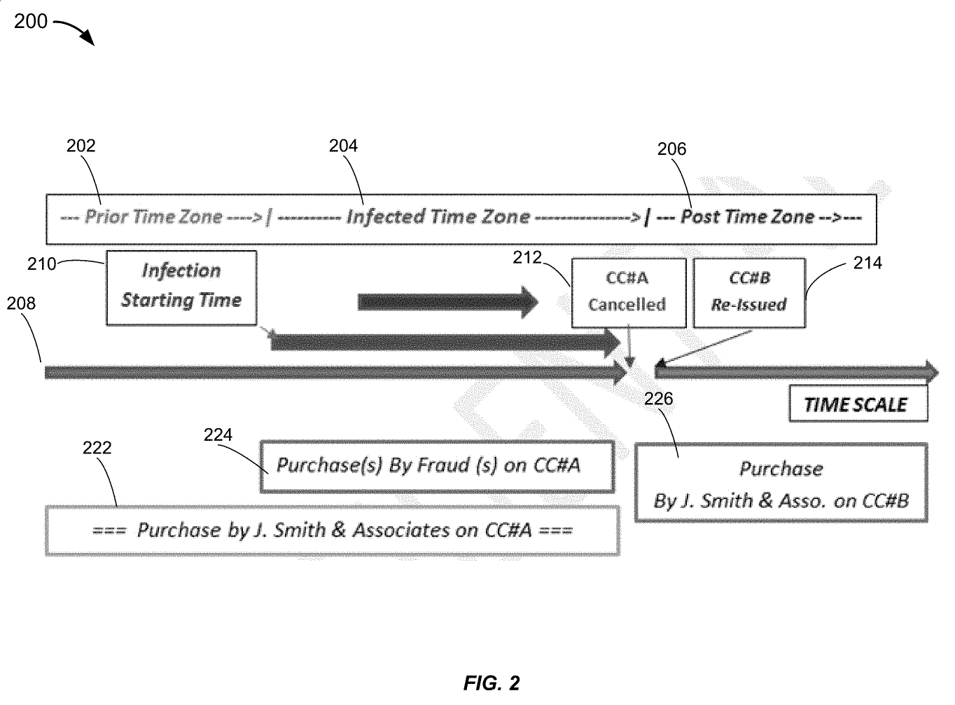

FIG. 2 illustrates an example of a time-dependent chart 200 illustrating a timeline of a compromised account according to embodiments of the present invention. Chart 200 illustrates three time zones: prior time zone 202, infected time zone 204, and post time zone 206. When an account (e.g., an email account or a credit card account) is issued to an owner, the owner may activate the account and begin using the account at an activation starting time 208, as is illustrated with a green arrow. For example, as shown in FIG. 2 element 222, J. Smith & Associates may be the owner, and authorized users may conduct transactions on account A.

At the infection starting time 210, attackers (intruders) may compromise the owner's account and begin making unauthorized transactions without the owner knowing that their account has been compromised. As shown at 224, the attackers may be conducting fraudulent transactions on account A. Multiple attackers may exist, as is shown with two red arrows. During the infected time zone 204, transactions can be made by both the original owner and the attackers. Since both the attackers and the owner of the account are making transactions during this period, the data elements that are associated with the account may be different. For example, the attacker may use an email address, IP address, and a shipping address that is different than what is used by the owner. When the original owner discovers that their payment account has been comprised, the original owner may cancel account A 212 and the issuer may re-issue a new account B 214 to the original owner.

A. Prior Time Zone

During the prior time zone 202, transactions are conducted by the original owner of account A and users authorized by the original owner. The transactions may include transactions initiated by the original owner and those authorized by the original owner such as: family members, colleagues, assistant, employees, etc. During this period, the access requests associated with the transactions may be identified as legitimate access requests. The authentication data from these legitimate requests may be collected, processed, and recorded. This authentication data may be used as a baseline cluster for identifying future legitimate access requests. For example, as the data elements corresponding to transactions conducted by J. Smith & Associates are identified as legitimate, these data elements may be used as a baseline to compare against incoming transaction data to ensure that the data elements are consistent. Inconsistent data elements in an access request may be identified as fraudulent.

B. Infected Time Zone

During the infected time zone 204, attackers may compromise the owner's account by obtaining an account number and potentially any password or other secret data. For an example of an email account, an attacker can obtain a login (which may be the email address) and a password. Once the compromised data is obtained, an attacker can begin making fraudulent access requests (e.g., unauthorized login to an email account or unauthorized purchases) at the infection starting time 210. During this time zone, the owner may be unaware that the account has been comprised. As a result, this period may include both authorized purchases and unauthorized purchases. Using conventional techniques, valid purchases by the owner may get rejected (e.g., based on high number of transactions as a result of the fraudulent access requests), and invalid purchases by the attacker may get authorized.

As discussed above, data elements from transactions conducted by the original owner of account A may be compared against incoming data elements form new transactions. The data elements associated with transactions conducted by the attackers may be different than the data elements associated with transactions conducted by the original owner of account A. Accordingly, because of the inconsistent data elements, the attackers may be identified.

The manner of measuring a level of consistency (or equivalently a level of inconsistency), e.g., so as to identify an access request as fraudulent, may be performed in various ways. In one implementation, a transaction may be identified as fraudulent if one data element is different from the baseline (legitimate) cluster. A second level of authentication can be used in such circumstances, e.g., via message sent by text or email, so as to allow a user to identify the access request as legitimate. In another implementation, the number of inconsistent data elements can be required to be more than a specified number (e.g., 2, 3, 4, etc.) or a specified percentage of data elements in the authentication information (e.g., greater than 50%, 60%, 70%, 80%, 90%, 95%, etc.). A single data element may be deemed inconsistent when it is not an exact math with a data element in a corresponding field of a legitimate cluster. In other embodiments, some level of mismatch may be allowed.

During the infected time zone, several issues may arise. Transactions submitted by the attackers may be accepted. This may result in chargebacks where funds are returned to the original owner. In addition, during the infected time zone 204, transactions submitted by the original owner may be rejected because the transaction may now be considered suspicious due to the unauthorized transactions by the attackers.

C. Post Time Zone

The post time zone 206 begins when the owner cancels the account 212 and when a new account is re-issued 214 to the owner. During the post time zone 206, transactions by the owner may be rejected because the data elements associated with the re-issued account are linked with the data elements associated with the original account. For example, the re-issued account may be associated with data elements, such as the owner's fingerprint, email address, IP address, and phone number. These data elements may be linked to the original account that was comprised. Since the re-issued account is associated with data elements that are in common with the compromised account, transactions conducted with the re-issued account may be rejected. In addition, the attackers may continue to use the same fraudulent data elements from the original account with other compromised accounts. Accordingly, the data elements that were associated with the original payment account may be flagged as suspicious or fraudulent data elements.

Embodiments can address such problems of authorized user and attackers accessing a resource contemporaneously, as well as instances where an authorized user is issued a new resource, e.g., a new email or payment account. Data structures for use in a fraud detection system are described below. The ability of the new account being saved from the past attacks can be referred to as redemption.

### III. DATA STRUCTURES FOR CREATING PROFILES OF ATTACKERS

Some embodiments can generate a data structure that provides statistically reliable data allowing a security application to detect potential instances of fraudulent use of a payment account. The data structure can be generated using data elements associated with transactions from authentication requests. Over time, as new data elements are added and linked to the data structure, the statistical reliability of the data structure increases.

Once the data structure is established, valid users of the resource may be identified. In addition, clusters within the data structure may be identified from the data structure. Each cluster (also referred to as a “Cyber Motif”) may be identified as corresponding to legitimate authentication requests or potentially fraudulent authentication requests, which may ultimately be legitimate (e.g. representing an authorized user's requests, such as assistant, family members, etc.). For example, a baseline cluster may be identified as legitimate authentication requests conducted by the owner of the resource. The remaining clusters may be classified as transactions that are suspicious or fraudulent.

New authentication requests may be compared to the baseline cluster. By comparing the new authentication requests with the baseline cluster, a fraud detection system can make a more reliable determination of a potential fraud event in real-time during the transaction itself. For example, an authorization system (e.g., implemented using access server 120) would not have to wait for time to elapse for a chargeback to occur in order to determine whether a transaction is fraudulent. Instead, the fraudulent transactions may be determined in real-time on its first attempt.

The data structure may also be beneficial for various users for other purposes. For example, an issuer modeling team, system engineer, business units may use the data structure for research purposes. Such data structures can also be used as evidence of how criminal activities traverse through different clusters of different resources, take over the identifications of the resources, and cross activities on different resources (e.g., as discussed in section VI). For example, in financial security: (1) Issuers can use it to do risk evaluation at profile level to assist decision in new account approval/existing account maintenance; and (2) Card association networks, acquires, merchants, 3rd party fraud solution providers, all of which can use it to provide protection against fraud activities through their own channels (e.g., determining whether a transaction is suspicious or fraudulent). In other industries, it can be used for identity-related protection scenarios: (1) Identity theft detection and protection by credit bureaus and 3rd party services; (2) Health care fraud: similar data structures with its own characteristic data elements and identifiers to detect and prevent health care fraud; (3 Insurance fraud: similar data structures with its own characteristic data elements and identifiers to detect and prevent any insurance fraud; and (4) Anti-money-laundry by financial institutions and government.

A. Creating an Initial Data Structure

A data structure of data elements may be created over time for the purpose of real-time authentication of new access requests (also referred to as authentication requests). The data structure can be generated by collecting and linking data elements from multiple new access requests over time. The data structure can have nodes that correspond to the data elements. As new authentication requests come in, a system can determine whether data elements of the new transaction match the existing nodes in the initial data structure.

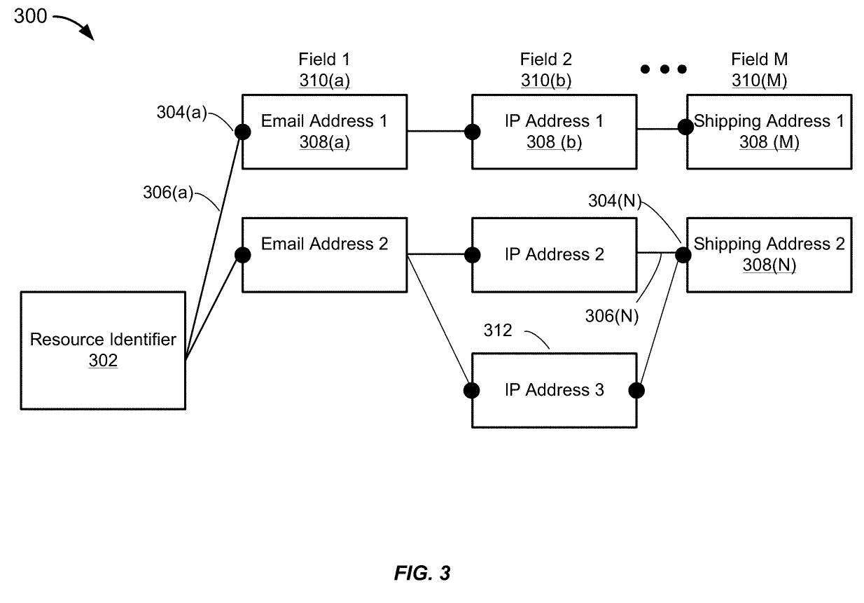

FIG. 3 illustrates an exemplary initial data structure 300 in embodiments of the invention. The initial data structure 300 may be generated using data elements from past authentication requests. The initial data structure 300 may include a resource identifier 302. Generally, when an authentication request is received, the authentication request may include a resource identifier and multiple data elements. The resource identifier 302 may be a payment account number, token number, digital wallet identifier, finger print, IP address, shipping address, billing address, etc., or any logical combinations of these components.

As shown, data structure 300 includes a plurality of existing nodes 304(a)-304(N) that include existing data elements 308(a)-308(N) that correspond to fields 310(a)-310(M). Data structure 300 can have a specific ordering to the fields, and a null value can exist in a node when the data element for the corresponding field is not present. More than one data element may exist for a field, as a user may initiate an access request in a different manner at different times, e.g., using a different IP address. Different users may also initiate legitimate access requests for a same resource, e.g., a same cloud storage account may be shared by multiple users or a same credit card may be shared by multiple users.

As shown in FIG. 3, field 310(a) may include only email addresses that were used when conducting an access request with resource identifier 302. The owner of resource identifier 302 may authorize the use of the resource identifier 302 to additional users such as his family members, colleagues, assistants, employees, etc. Similarly, fields 310(b)-310(M) may include fields for a shipping address, device fingerprint (e.g., one or more device identifiers, such as operating system, MAC address, web browser configuration information, TCP/IP configuration, IEEE (802.11) wireless settings, and hardware clock skew, which collectively can provide a unique identification of a device), IP address, etc., which were used when conducting an access request with resource identifier 302. The fields are not limited and additional fields can be created to accommodate new data elements. For example, other data elements may include a user name, an account identifier (e.g., username or email), a payment account number, token number, digital wallet identifier, etc. Accordingly, if the initial data structure 300 does not have a field for a new data element such as a user name or an account identifier, additional fields may be added to accommodate the new data elements.

The data structure can have connections 306(a)-306(N) that link the existing data elements 308 together. The connections can be defined as pointers from one node to another. Thus, a node can contain a data element and one or more pointers to one or more other nodes. A connection can indicate that the linked data elements were present in a same access request. In some implementations, a connection can have an associated strength that corresponds to a number of access requests that share the data elements. One node can point to another node, indicating the two nodes are bound together, and presented in one request, for instance, node 308(a) is bound with node 308(b). The binding relation can be passed from node 308(a) to node 308(M), which can be referred to as a full bind.

As shown in FIG. 3, a node can point to more than one other node, e.g., when an email address 312 shows up in different access requests having different IP addresses. Full binds can overlap, i.e., share nodes. Email address 2 and shipping address 2 are shared (overlapped nodes) among two full binds that have differing IP addresses. The data structure can store the node connectivity relation, but also store the connectivity strength in combination with the pointer to the particular other node. The connectivity strength could be the frequency of the binding relationship of the given two nodes.

B. Updating the Data Structure

As mentioned above, a data structure can be updated as authentication information from new access requests is received. The data structure can be updated by adding new nodes when new data elements are identified. In some embodiments, a connection strength between nodes can be updated when some nodes have the same data elements as the current authentication information, and thus the connection becomes stronger.

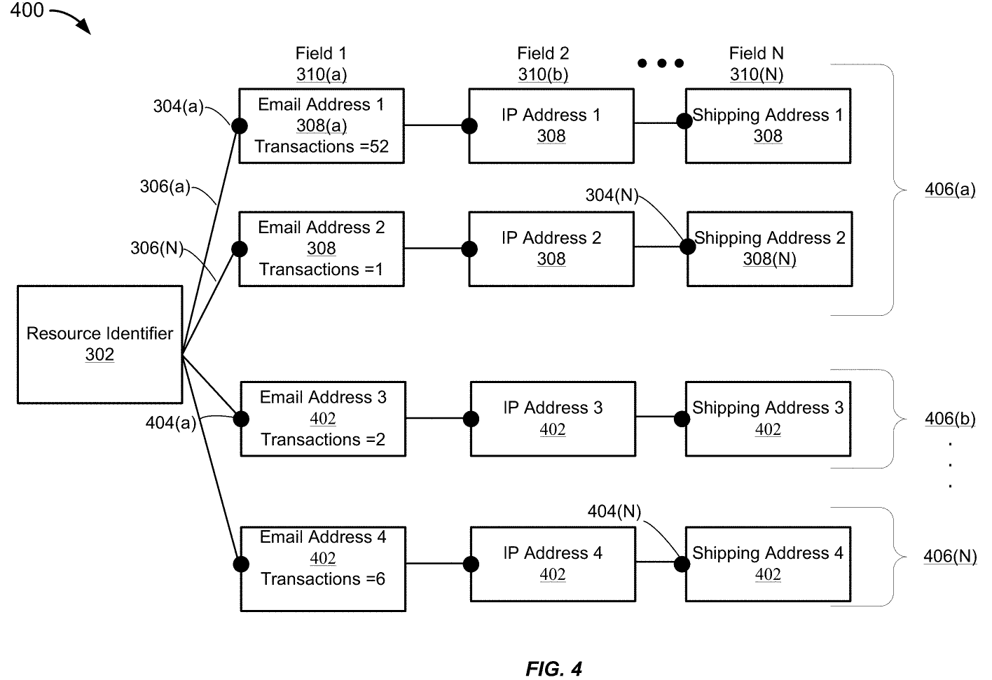

FIG. 4 illustrates an exemplary updated data structure 400, in embodiments of the invention. Additional nodes have been added to initial data structure 300 to obtain updated data structure 400.

As new authentication requests are received, the system can perform pattern recognition techniques to determine the extent that the current data elements of the new authentication request match the existing nodes 304(a)-304(N) in the initial data structure 300. For example, the current data elements of the new authentication request can be compared to the existing nodes 304(a)-304(N) in the initial data structure 300 to identify any new data elements 402 that do not match the existing data elements 308 in the initial data structure 300.

If new data elements 402 are identified, the new data elements 402 may be added to the initial data structure 300, shown here as additional nodes 404(a)-404(N). The additional nodes 404(a)-404(N) may be added to the one or more clusters 406(a)-406(N) in the data structure. Each of the one or more clusters 406(a)-406(N) may represent a pattern of legitimate authentication requests or a pattern of potentially fraudulent authentication requests. In other words, the different clusters may be classified as transactions conducted by the original owner, or transactions classified as suspicious or fraudulent. For example, as shown in FIG. 4, cluster 406(a) may represent legitimate transactions conducted by the owner and his wife while cluster 406(b)-406(N) may represent transactions by attackers.

In addition, the existing nodes, e.g., 304(a)-304(N), may be stored in the initial data structure 300 in one or more clusters, e.g., 406(a)-406(N), based on a commonality of the connections among the existing nodes. The clusters may already be identified before the new authentication request is received. The clusters may be saved as a list of nodes that correspond to a particular cluster. In the example of FIG. 4, cluster 406(b) can be defined by storing identifiers of the nodes for email address 3, IP address 3, and shipping address 3. In this manner, the properties of cluster 406(b) can be identified based on the nodes within the cluster. In some embodiments, a node can belong to more than one cluster, as there can be cross-interaction among clusters, as opposed to the uniform rows shown in FIG. 4.

The additional nodes to be added may be allocated memory space on an as-needed basis. For example, when a new data element is identified, memory for a new node can be allowed. Then, the new memory can store pointers to any nodes having a same data element in an access request as the new data element.

If a new cluster is added, the new cluster may initially be identified as potentially fraudulent, with a later classification occurring based on the status of requests associated with the cluster. Example statuses include: passed (access granted) and not turned into fraud, passed and turned into fraud, and declined and not knowing fraudulent status. In some embodiments, the reporting of fraudulent events may have a time delay effect.

In updating the classification of the clusters, a cluster can be re-classified, separated out from a larger cluster, or both. For example, a subcluster (nodes all found in an access request) can initially be added to an existing legitimate cluster. But, if a breach is reported for that access request, then the sub-cluster can be separated out as a new cluster that is classified as fraudulent. And, even if a new cluster is added, its classification may not be known until a final status of the request is known, at which the classification can be updated.

C. Method

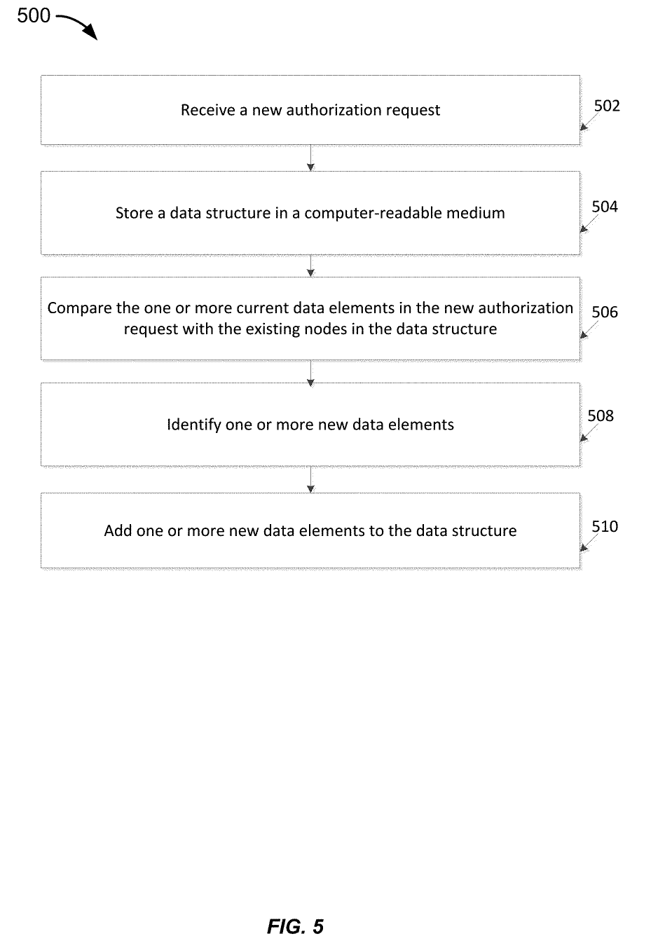

FIG. 5 illustrates a flow chart of a method 500 for generating a data structure in accordance with an embodiment of the invention. Method 500 may be performed by a computer system, for example, an access (authentication) server of a resource security system (e.g., as shown in FIG. 1) that analyzes authentication requests for accessing a resource. More specifically, method 500 may be performed by access server 120. In method 500, a data structure for managing access to a resource already exists, e.g., as generated in a manner described herein.

In step 502, a new authentication request to access a protected resource is received. The new authentication request may include a resource identifier and one or more current data elements. The new authentication request may be received any one of various device, e.g., user device 150, access device 160, or request computer 170 of FIG. 1. The new authentication request can be initiated by a user when access to the protected resource is desired. As described above, the protected resource can be, for example, a physical resource, a computer resource, or other electronic resource for which authentication information is required before access is provided. For instance, an account number may be provided, as well as verification data.

An authentication request can have a specified format, e.g., the length and location of the data within a packet or larger message. In other embodiments, each data element can be sent with a label (tag) that identifies the data element, and potentially its length. The labels can correspond to fields (e.g., fields 310) of the data structure. The data elements in an access request can be considered as binded together, which can provide connections for the data structure.

In step 504, a data structure may be stored in a computer-readable medium that is accessible by computer system. The data structure may be stored in any suitable manner, e.g., as an array, a linked list, a graph database, or as a table in a database. For example, as discussed with reference to FIG. 3, the initial data structure 300 may be stored in a database. The initial data structure 300 may be associated with resource identifier 302 and existing data elements 308 that were obtained from previous authentication requests. The resource identifier 302 may correspond to the particular table in the database, and thus may be used as a primary key in a query that accesses the database to obtain the data structure. The initial data structure 300 may have existing nodes 304(a)-304(N) that corresponds to the existing data elements 308. The initial data structure 300 may have connections 306(a)-(N) that indicate which existing nodes 304(a)-304(N) have occurred in a same previous authentication request.

The data structure can be initialized in the following manner. The resource identifier can be registered for the protected resource, e.g., when a user sets up an account. At the time of registration (e.g., via Web registration), the system can receive one or more initial data elements as part of registering the resource identifier. A cluster of the data structure can be generated to include one or more nodes corresponding to the one or more initial data elements.

In step 506, the one or more current data elements in the new authentication request are compared to the existing nodes in the data structure. For example, as discussed with reference to FIG. 3 and FIG. 4, as new current data elements from the new authentication requests are received, the new current data elements are compared to the existing nodes 304(a)-304(N) in the initial data structure 300 to determine if the current data elements match the existing data elements 308.

The comparison can be performed in a variety of ways. For example, the field of each new data element can be identified (e.g., using a tag or other identifier), and the data element can be compared to each node for the field. The comparison can be a numerical comparison or a regular expression comparison, or other technique as will be known to one skilled in the art.

In step 508, responsive to step 506, one or more new data elements are identified from the one or more current data elements that do not match one of the existing nodes of the data structure. For example, referring to FIG. 3, the one or more current data elements that are associated with the new authentication request are compared to the existing nodes 304(a), . . . 304(N) in the initial data structure 300. If the data elements do not match, the non-matching data elements may be identified as new data elements. For example, an email address of JohnDoe@xyz.com does match the email address of JDoe@abc.com. In the example of FIG. 4, email address 3 can be identified as not corresponding to email address 1 or 2, and thus be identified as a new data element.

In step 510, the one or more new data elements are added as one or more additional nodes in the data structure. For example, as discussed with reference to FIG. 4, the one or more new data elements 402 may be added as additional nodes 404(a), . . . 404(N) as shown in the updated data structure 400. In one implementation, an additional node may be allocated new memory and the corresponding data element added, with a pointer to related nodes.

The updated data structure 400 may have one or more clusters 406(a)-406(N). Each cluster from the one or more clusters 406(a)-406(N) may represent a pattern of legitimate authentication requests or a pattern of potentially fraudulent authentication requests. For example, existing cluster 406(a) may represent a pattern of legitimate authentication requests and new cluster 406(N) may represent a pattern of potentially fraudulent authentication requests.

When the additional nodes 404(a)-404(N) are added to the updated data structure 400, the additional nodes 404(a)-404(N) may be stored in the existing cluster 406(a) that represents a pattern of legitimate authentication requests, or in a new cluster 406(N) that represents a pattern of potentially fraudulent authentication requests. Connections between nodes can be added as appropriate, e.g., based on which nodes matched data elements in the authentication request. After creating a new cluster, the new cluster can be classified, e.g., as good, suspicious, or bad (fraudulent). The initial identification of potentially fraudulent allows later analysis to result in such classifications. The classification can use reporting breaches (e.g., chargebacks, data theft, or other types of breaches) associated with particular authentication requests. Clusters associated with such breaches can be identified as bad, and can be added to a set of known fraudulent clusters, as described in section VI. These classifications can be stored and used to determine whether to authorize future requests.

Based on the comparison in step 506, a computer system can determine whether to authorize access to the protected resource in response to the new authentication request. In response to determining that access is to be granted, an authorization signal can be sent to a resource computer (e.g., resource computer 110 of FIG. 1) for granting access to the protected resource.

In some embodiments, whether to grant access can be determined in the following manner. The amount of the one or more current data elements that match the existing nodes of the existing cluster can be determined, and this matching amount can be compared to a threshold. In various implementations, the amount can be a number of the one or more current data elements that match the existing nodes of the existing cluster, or a percentage of the one or more current data elements that match the existing nodes of the existing cluster. In various examples, the measurement of a matching amount of matching could be different measures with/without different units, such as a function, a probability, a score, or a rate, where units could be per give time, per given change in time, etc. Each matching node can contribute uniformly or be assigned differing weights for contributing to the amount. Access to the protected resource can be granted based on the amount exceeding the threshold. In further embodiments, the matching amount can be a combined level determined from respective amounts (e.g., a sum of number of matching nodes, percentage of nodes, a score, etc.). Each of the respective amounts can be assigned a weight. Further, the matching amount can correspond to a number of criteria that are satisfied, with each criterion requiring a sufficient amount of matching. Thus, different measurements of matching can each be required to be at least a certain amount.

### IV. USE OF DATA STRUCTURE

According to embodiments, a data structure may be used by an access server (e.g., via automatic operation) or an operator (administrator) of the access server when reviewing transactions to make decisions on whether to accept or reject new authentication requests. Display of a physical diagram including the data structure may help an operator quickly determine whether the authentication request may be legitimate or potentially fraudulent. The use of the data structure is not limited to operators (e.g., merchant operators). Other parties such as issuers, credit bureau associates, acquirers (e.g., using a request computer), and other third parties may use the data structure for their advantage. Such other parties may use such a data structure in protection of other resources, e.g., of a same type. For instance, the same attackers might attack other resources, and a profile (via a cluster in the data structure) can allow a server of another party to detect fraudulent requests much quicker, as the proper knowledge of the received data structure can be leveraged.

A. Identification of Baseline Cluster that Represents Legitimate Requests

A baseline cluster from the data structure may represent statistically reliable data on legitimate authentication requests. For example, referring to FIG. 4, the updated data structure 400 represents a data structure that has been generated over time. Under field 1, 52 transactions have been conducted using “Email Address 1” without any reports of a fraudulent access (e.g., an intrusion such as a hacked email account or a chargeback when the resource relates to a payment account). Without any report of a fraudulent access across a sufficiently long time interval (e.g., accounting for a reporting lag and assuming all fraud will be reported), a cluster can be identified as legitimate. Accordingly, this high amount of usage may indicate that “Email Address 1” is legitimate. Thus, cluster 406(a) can be identified as representing legitimate transactions conducted by the original owner and any other authorized users of resource identifier 302. Hence, cluster 406(a) may be identified as a baseline cluster to which new authentication requests are compared to determine whether the requests are legitimate or fraudulent.

When a resource initially is created, there may not be sufficient information to identify a baseline cluster, or at least not defined as completely as desired. A user may specify data elements of certain fields as a seed when registering or creating the resource, e.g., when creating an email account, a cloud storage account, payment account, or a set of badges for accessing a building (e.g., which may require a password or other criteria). The specified data elements can act as the baseline at first. But, in some embodiments, the access server needs to be more flexible than requiring access corresponding to only the specified data elements, e.g., as a user may get a new device, email, and/or IP address (e.g., when Internet provider changes). Thus, the first usage may require that at least a certain number (or percentage) of the data elements match the specified data elements, but allow a few (e.g., one or two) new data elements. When less than all of the data elements match with the baseline cluster, the new access request can be considered to be affiliated with the baseline cluster, with the percentage matching being an affiliate degree of intensity. These new data elements can be added to the baseline cluster, which initially corresponds to the data elements specified at creation of the resource. The new data elements can then be re-used, potentially solidifying their status as legitimate.

A data element can have different strengths (statuses) of being legitimate. As mentioned above, values specified at time of creation can be assigned a high strength (e.g., 9 out of a scale of 1-10). After a specified number of threshold usages (e.g., 20, 30, etc.), the strength can be increased to 10. In other embodiments, the strength can continue to rise (e.g., no specified maximum or at least a higher maximum than 10) as the data elements continues to be seen in access requests that have not been flagged as fraudulent. The strength can start off at another value, and increase in increments after meeting various thresholds.

The strength of a matching data elements can allow a new data element in a same request to be added to the baseline. For example, the strength scores can be added for each matching data element, and the total score can be required to be above a certain threshold before new data elements are added to a legitimate cluster, which may be the baseline or another cluster corresponding to a different legitimate user than the one who specified data elements at the time of creation/registration of the resource. Before being added to a legitimate cluster, a data element can be uncategorized or in a cluster that is indeterminate (i.e., not legitimate and not fraudulent). A data element in an indeterminate cluster may not have an associated strength or a value of zero. Data elements of a fraudulent cluster can have negative strengths, as is described below. Further examples of different clusters include suspicious (which may be considered indeterminate), legitimate, or fraudulent.

In addition to authentication information, other parameters of the access requests can be obtained, such as location of request, request velocity (e.g., number of transactions within a time period, potentially accounting for amount).

B. Cluster that Represents Fraudulent Requests

Clusters representing suspicious or fraudulent transactions may also be identified. For example, in FIG. 4, cluster 406(b) can be identified as fraudulent because only two transactions have been conducted, and the data elements 402 are not consistent with the data elements in baseline cluster 406(a). The categorization of fraudulent could change at a later time, e.g., if additional requests included data elements from a legitimate cluster.

The data elements of a fraudulent cluster can also have scores, e.g., negative numbers showing a weakness of the data element being part of a valid request. These score could contribute to determining whether a new authentication request is legitimate, e.g., if the new request included one or more data elements of a legitimate cluster and one or more data elements of a fraudulent cluster. In a similar manner as for positive strengths, the negative values can be used to add a data element to fraudulent cluster. For instance, a number of times that a data element appears in a fraudulent request may be used as a negative score. Also, if a request has been specifically identified as an intrusion (e.g., a chargeback or a detected attack), the scores for those data elements can be increased much higher (e.g., by 5, 10, etc.) since there is confirmation of an intrusion.

Besides having scores associated with each data elements of a cluster, a fraudulent cluster can have an associate score related to how fraudulent the cluster is. Similar to an example above, the cluster can have a higher fraudulent score (e.g., high negative number) if a specified number of intrusion attacks have been explicitly identified, e.g., by a user or by malware/virus software.

C. Comparison of Clusters with Incoming Authentication Requests

As new authentication requests are received, pattern recognition techniques can be used to determine to what extent the data elements of new transactions match to the data nodes in the baseline cluster or other legitimate cluster. Data elements of new transactions may be compared to the existing clusters to determine whether the new transactions are consistent with the existing clusters in the data structure. For example, if the new transactions are consistent with the baseline cluster (e.g., cluster 406(a)), the access request may be authorized. However, if the new access requests are inconsistent with the baseline cluster or other legitimate cluster, the access request may be denied or considered potentially fraudulent. The determination of which cluster a new authentication request belongs can be referred to as segregation.

The criteria for whether a new access request is sufficiently consistent can be measured as described herein. For example, a certain number or percentage of new data elements can be required to match to current data elements of a legitimate cluster. The contributions from the matching to different data elements can be weighted differently, e.g., using the scores described above. Whether a specific data element matches can be determined using standard operations, such as an equal sign to determine if two numbers are the same. Many programming language allow an equal sign to also be used with strings, e.g., for use to compare addresses or email addresses.

By comparing new authentication requests with a baseline cluster that has been generated over time and identified as being legitimate, an access server may make a more reliable determination in real-time regarding whether new access requests are potentially fraudulent. Comparing the baseline cluster to new authentication requests may also help reduce false positives. For example, with the baseline cluster, an access server will have a better understanding about which incoming transactions are suspicious and reject those transactions rather than approve them.

An access server may also compare incoming new authentication requests with clusters within the data structure that have been identified as being suspicious or fraudulent. This allows the access server to flag any new authentication requests that match the profiles (clusters) of the suspicious or fraudulent clusters so that the access server can further evaluate the authentication requests.

In some embodiments, the comparison can proceed as follows. When an access request is received, embodiments can determine a Degree of Affiliation (DoA) to a baseline cluster on every possible combination of the binding in current transactional elements. Examples below use a combination of two elements, but there can be more than two.

$$DoA ( {Transaction}_{new} \to BaseLine Clusters ) = {\sum }_{s ∈ S} {\sum }_{i , j ∈ C} {\sum }_{t ∈ H} {w}_{s} * {w}_{i , j} ( t \vert s ) * Trans ( freq ( ( {e}_{i} , {e}_{j} ) \vert t , s ) )$$

“C” is the set of all possible index of binding elements in current transaction. If we pick 2 of them: Set of index {1, 2, 3}, C={(1,2), (1,3), (2,3)}. “S” stand for request final status, e.g., accepted and not fraud, accepted and fraud, or rejected. “t” corresponds to a moving time window on timeline backward, e.g., a weekly window. “H” stand for Historical time. “freq” is the function that counts the event of binding of two elements in that given time window. “W” are all the weights: W_ij(t|S) is driven by the marking reporting lag time distribution, given the status of the historical transactions, and given the combination (ith, jth) element; and W_s can be empirically determined. “Trans” can correspond to any kind of transformation function, if necessary, e.g., logarithm transformation.

Summing all the weights together provides a measure of the affiliation on a current request to its historical events from that resource identifier. This example measurement can compare all requests and learn the optimal threshold for decision. The threshold can be a percentile of the current calculated DoA's relative position in all observed/calculated DoAs from all requests. The value of DoA could be positive or negative. The larger the positive value is, the higher the probability of a current request being affiliated with a legitimate cluster, and the smaller the negative value is, the higher the probability of a current request being affiliated with a fraudulent cluster.

Accordingly, as examples, a learning model can determine: (1) a similarity between a current access request to an existing cluster; and (2) the legitimate likelihood of an established/existing cluster. Errors can exist at the beginning of the learning (training) process, and an optimal threshold for classifying whether the data elements should be added to an existing cluster or for creating a new cluster can be determined. Complementary information can be used to determine whether to add to a baseline cluster, e.g., password verification via SMS or via other communication channels, verification via biometrics, or other types of verifications. Thus, secondary authentication techniques can be used confirm whether data elements of an authorization request can be classified as legitimate, and such classification can be used for later requests where secondary authentication is not available. In some embodiments, data elements of requests having secondary authentication can be assigned a higher weight, where a legitimate classification is assigned once data elements of a cluster occur a sufficient amount (including potential weighting) without a breach being reported.

### V. EXAMPLE DATA STRUCTURES

The examples below provide data structures created from actual attackers making fraudulent access (authentication) requests. The different data structures show differing numbers of nodes. Connections are shown between nodes that were bound together in a single access request. Clusters for each data structure are labeled on the right.

### A. Example 1

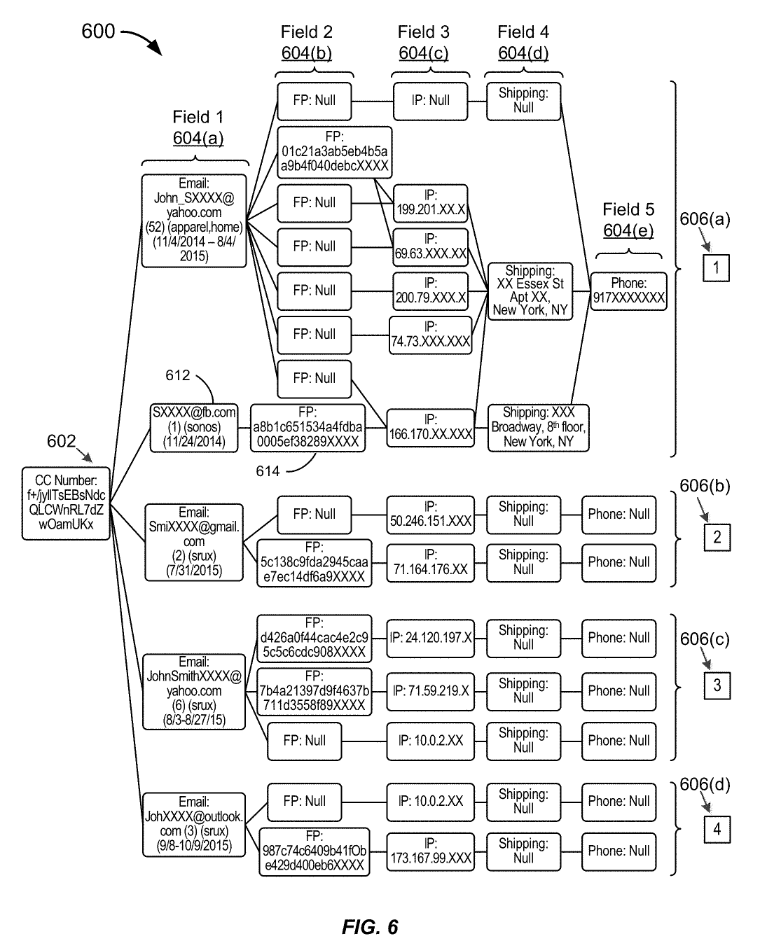

FIG. 6 shows an example of a data structure in embodiments of the invention. The data structure 600 uses a credit card number 602 as a resource identifier to generate the data structure. The data structure 600 includes five data fields, 604(a) -604(e), that were used in connection with access requests for transactions associated with credit card number 602. In this example, field 604(a) includes email addresses, field 604(b) includes device fingerprints, field 604(c) includes IP addresses, field 604(d) includes shipping addresses, and field 604(e) includes phone numbers.

The data structure 600 results in four clusters, 606(a) -606(d). As shown in the diagram, cluster 606(a) represents a baseline legitimate cluster while clusters 606(b)-606(d) are suspicious or fraudulent clusters. In field 604(a), the diagram indicates that the email address (e.g., data element), John_SXXXX@yahoo.com, was used in 52 credit card transactions between 11/04/14 and 08/04/15. Because there were no reports of fraudulent or unauthorized purchases in connection with this email address, transactions associated with this email address are considered legitimate. Thus, cluster 606(a) may be identified as a baseline cluster that represents a pattern of legitimate authentication requests.

Baseline cluster 606(a) also includes email address SXXXX@fb.com which has only one transaction associated with the credit card number 602. Although the email address SXXXX@fb.com has only one transaction associated with credit card number 602, the corresponding access request has common data elements with access requests that also included the email address John_SXXXX@yahoo.com, such as a common shipping address, IP address, and phone number. All of the transactions have the same phone number. When such a data element is so pervasive, it can be allocated a high strength for predicting which cluster a new access request belongs.

Accordingly, baseline cluster 606(a) includes transactions associated with both John_SXXXX@yahoo.com and SXXXX@fb.com. Thus, the baseline cluster can include more than one email address. This example shows that a cluster can include various cross-connections among the data elements in the cluster, with some data elements only being present in certain access requests as other data elements. For instance, the email address 612 and device fingerprint 614 are data elements that are affiliated with the baseline when they first appear in an access request, and then can be added to the data structure as part of the baseline cluster 606(a) given the sufficient overlap (consistency) with the data elements of the baseline cluster 606(a).

As shown, the email John_SXXXX@yahoo.com occurs with various device fingerprints and IP addresses. Some of the device fingerprints are labeled as Null. The Null nodes are considered as differing from each other, so as not to have errant affiliation identified. The top IP address and shipping address are also null. Thus, other data elements besides email (or another primary data element) are not necessarily required. A primary data element (e.g., one for which a value is required) may be designated by which field corresponds to that data element.

There is no overlap between the data elements (nodes) of the other clusters. Each of the different clusters has different emails, each with different combinations of fingerprint and IP address, with no information for shipping address or phone number. The different clusters can be identified by the separation in the nodes of the data structure, i.e., that there are no connections between the nodes. Whether or not there are connections can be determined, e.g., from whether there is a pointer from one node in one cluster (e.g., as determined from the definition of the cluster including specified nodes, as may be done with identifiers of nodes or nodes can store an identifier of a cluster).

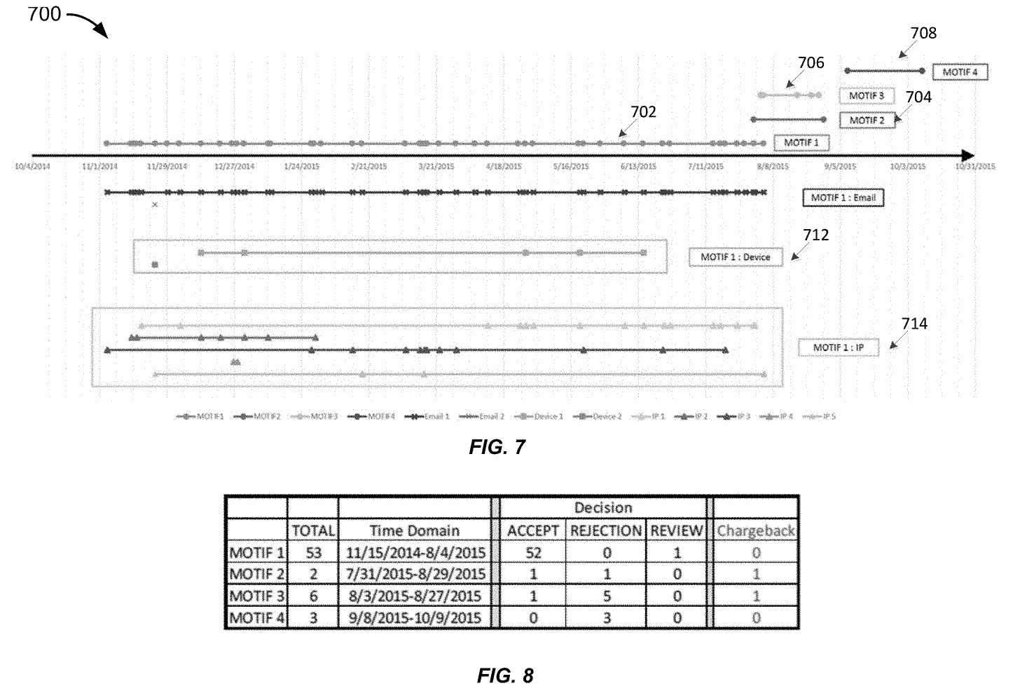

The access requests for clusters from the data structure may be presented in a time diagram to illustrate the timeline and frequency of the transactions for each cluster. For example, referring to FIG. 7, MOTIF 1-702 (e.g., cluster 1 from FIG. 6) is a baseline cluster which represents statistically reliable data on legitimate authentication requests. The diagram indicates that the transactions conducted for MOTIF 1-602 approximately ranges from November 2014 to April 2015. Similarly, shown in the diagram are the suspicious or fraudulent clusters from FIG. 6: MOTIF 2-704 (e.g., cluster 2), MOTIF 3-706 (e.g., cluster 3), and MOTIF 4-708 (e.g., cluster 4).

The performance of MOTIFs 1-4 from FIG. 7 are populated in FIG. 8. For example, as discussed above, MOTIF 1-702 is the baseline cluster. FIG. 8 reveals that for MOTIF 1, there are a total of 53 transactions in connection with MOTIF 1 where 52 transactions have been accepted and only one was under review. In addition, MOTIF 1 resulted in zero charge backs. Hence, the performance data confirms that MOTIF 1 is correctly identified as a baseline cluster.

The fraudulent requests associated with MOTIF 2-704 approximately range from Jul. 31, 2015 to Aug. 29, 2015. A total of two access requests were made in connection with MOTIF 2-704 where one request was accepted and one was rejected. The accepted request resulted in a chargeback, and thus there was one successful attack. Hence, the data confirms that MOTIF 2-704 is a fraudulent cluster.

The fraudulent requests associated with MOTIF 3-706 approximately range from Aug. 3, 2015 to Aug. 27, 2015. A total of six access requests were made in connection with MOTIF 3-706 where one request was accepted and five were rejected. The accepted request resulted in a chargeback, and thus there was one successful attack. Hence, the data confirms that MOTIF 3-706 is a fraudulent cluster.

The transactions associated with MOTIF 4-708 approximately range from September 2015 to October 2015. A total of three transactions were conducted in connection with MOTIF 4-708 where all three authentication requests were rejected. In addition, MOTIF 4-708 resulted in zero charge backs. Hence, the data confirms that MOTIF 4-708 is a fraudulent cluster.

Accordingly, there are fields from chargeback transactions that have not been detected by current mechanisms. Embodiments using a data structure and associated techniques can spot those transactions, as the data elements of the other motifs are not categorized into the good baseline MOTIF 1-702.

In some embodiments, FIGS. 6-8 can be used as visualization tools for an administrator of an access server. In addition or instead, a system can use the data structure to make automatic determinations as to whether to provide access to a resource, e.g., based on a consistency score of a new authentication request with the nodes of a legitimate cluster.

FIG. 7 is an example of a timeline graph having a time axis that may be displayed. A timestamp can be received for each of a plurality of authentication requests. Each of the authentication requests can be assigned to a cluster. The timeline graph can include each of the plurality of clusters with each of its authentication requests displayed at a time corresponding to the timestamp. Each cluster can be displayed with an indication of whether the cluster is legitimate.

FIG. 7 also shows a MOTIF 1-712 that is a subset of MOTIF 1-702, where the access requests corresponding to a particular device fingerprint are clustered together. This shows that not all of the valid requests will have the same device fingerprint, and thus it is preferable for systems to have flexibility in using such additional data elements, as is described herein. For example, a data element can be added to a legitimate cluster based on affiliation, which may require a specific number of authentication requests that are affiliated before being added. Motif 1-714 shows different IP addresses, which is even more common to vary.

The chargebacks are an example of an indication that one or more authentication requests associated with the new cluster are fraudulent. Such indication can be received from an administrator of the protected resource, e.g., an owner of an account or an IT professional that monitors electronic resources. Based on the indication, a new cluster can be identified as a fraudulent cluster associated with an intruder to the protected resource.

### B. Example 2

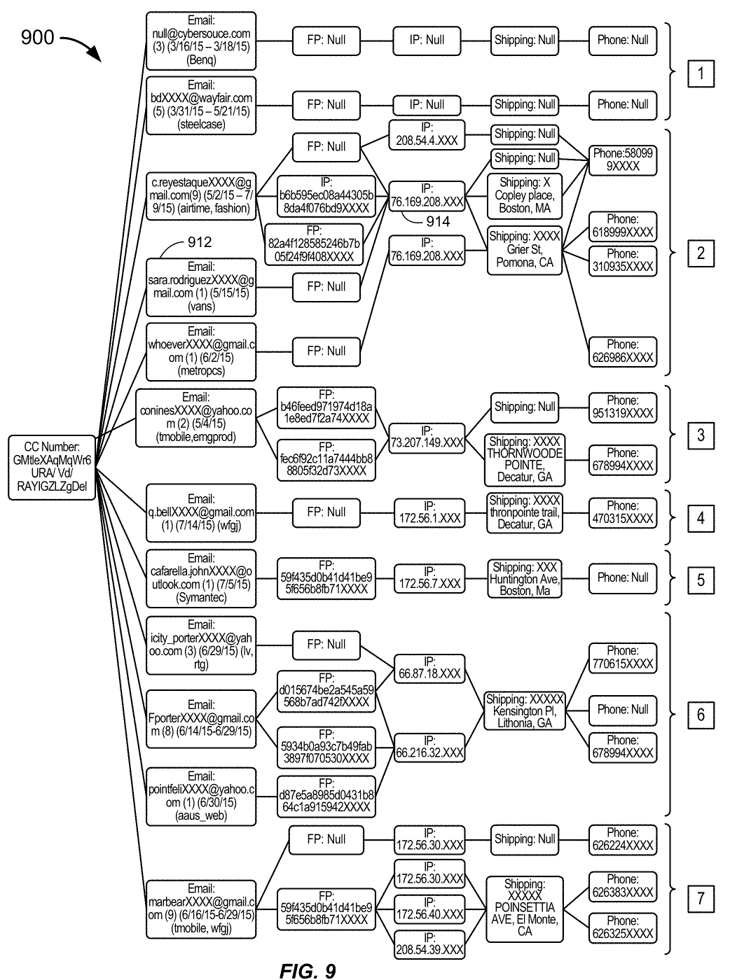

FIG. 9 shows another exemplary data structure 900 according to embodiments of the present invention. Cluster 1 is legitimate, but the other clusters are suspicious or fraudulent. The owner has only used the resource a few times. But, the potentially fraudulent clusters have used the resource many times, as shown in Table 1 below, which shows chargebacks. The infected time is quite long, i.e., the time when both the original owner and the attackers are submitting authentication requests.

TABLE 1
Clusters are shown with number of requests, time range of requests,
resulting decisions, and status of identification of any intrusions.

| | | | Decision | | | | |
|---|---|---|---|---|---|---|---|
| | TOTAL | Time Domain | ACCEPT | REJECTION | REVIEW | UNKNOWN | Chargeback |
| MOTIF 1 | 8 | 03/16/2015-05/21/2015 | 7 | 0 | 1 | 0 | 0 |
| MOTIF 2 | 11 | 05/02/2015-07/09/2015 | 3 | 8 | 0 | 0 | 3 |
| MOTIF 3 | 2 | 5/4/2015 | 1 | 1 | 0 | 0 | 1 |
| MOTIF 4 | 1 | 7/14/2015 | 0 | 1 | 0 | 0 | 0 |
| MOTIF 5 | 1 | 7/5/2015 | 1 | 0 | 0 | 0 | 1 |
| MOTIF 6 | 12 | 06/14/2015-06/30/2015 | 2 | 6 | 1 | 3 | 5 |
| MOTIF 7 | 9 | 06/16/2015-06/29/2015 | 0 | 10 | 0 | 0 | 0 |

As shown in FIG. 9, cluster 2 has three emails with the first email connected to two known device fingerprints and three IP addresses. Multiple phone numbers were also used. In this manner, when a new email address is used (e.g., email 912) in combination with IP address 914, which is already known to be bad, then the access request that includes email 912 can be denied access to the resource.

### C. Example 3

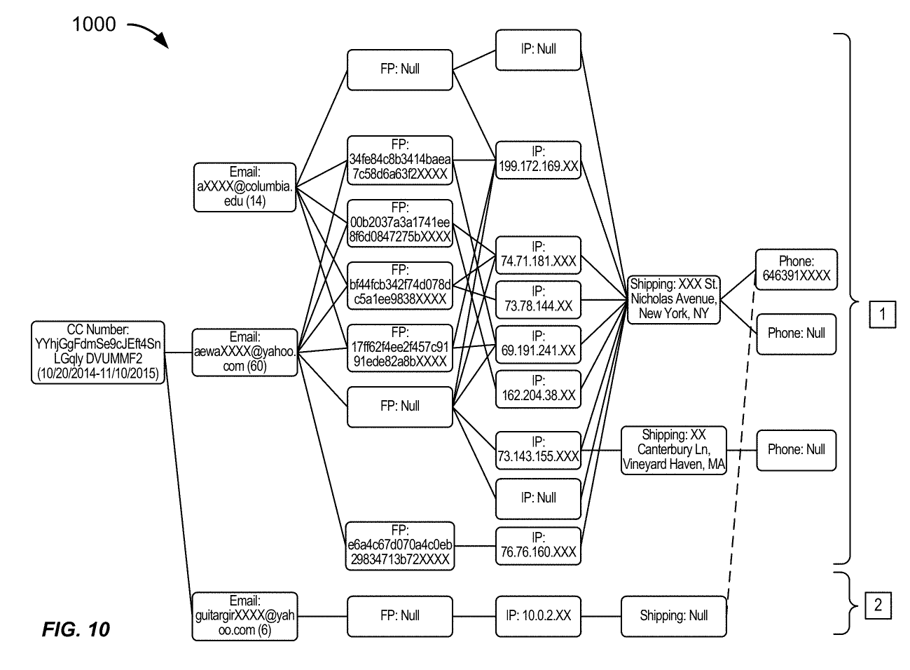

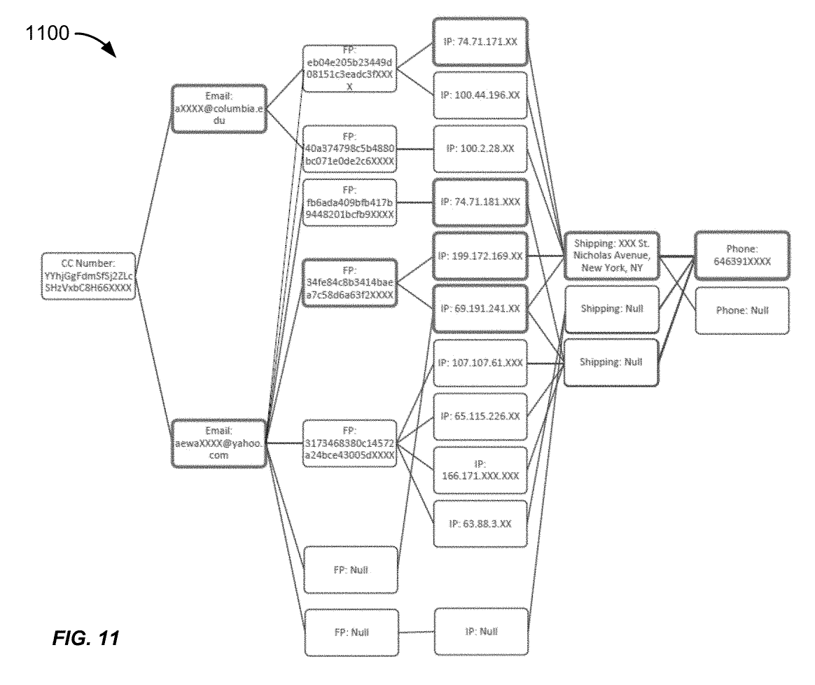

FIG. 10 shows an exemplary data structure 1000 for a first resource of an owner according to embodiments of the present invention. Data structure 1000 shows many authentication requests for the baseline cluster 1, and just a few for the fraudulent cluster 2. The owner canceled the resource and got a new resource issued as a second resource. FIG. 11 shows an exemplary data structure 1100 for a second resource of an owner according to embodiments of the present invention.

For the second resource, there are possibilities that when the original owner used the second resource, the owner will be rejected because the first resource was linked to the fraud activities. The highlighted boxes of data structure 1100 show the same data as in the data structure 1000 for the first resource. The legitimate cluster 1 of data structure 1000 can be related to the single cluster of data structure 1100, and thus the new access requests can be accepted, since they are from a legitimate user. Accordingly, embodiments can easily and naturally characterize the access requests for the second resource into the baseline cluster 1 in data structure 1000.

Table 2 shows the outcomes for the two resources

TABLE 2
Clusters are shown with number of requests, time range of requests,
resulting decisions, and status of identification of any intrusions.

| | | | Decision | | | | |
|---|---|---|---|---|---|---|---|
| | TOTAL | Time Domain | ACCEPT | REJECTION | REVIEW | UNKNOWN | Chargeback |
| MOTIF 1 | 74 | 10/20/2014-11/10/2015 | 74 | 0 | 0 | 0 | 0 |
| MOTIF 2 | 6 | 11/03/2015-11/09/2015 | 4 | 2 | 0 | 0 | 4* |
| MOTIF 1 New Account | 45 | 11/20/2015-05/22/2016 | 12 | 33** | 0 | 0 | 0 |

By using embodiments, the 4 accepted transactions from MOTIF 2 could have been prevented from becoming intrusions (chargebacks) by review or rejection. And, the 33 rejected transactions conducted by the original owner using the new resources could have been accepted.

### VI. VAULT FOR STORING POTENTIALLY SUSPICIOUS OR FRAUDULENT AUTHENTICATION REQUESTS

In some embodiments, a vault may be generated to store potentially suspicious or fraudulent authentication requests. For example, referring back to FIG. 4, the updated data structure 400 may have a one or more clusters 406(a)-406(N) representing legitimate or potentially fraudulent authentication requests. Cluster 406(a) may represent legitimate transactions conducted by the original owner of the resource identifier 302, and clusters 406(b)-406(N) may represent fraudulent transactions by attackers.

The one or more new data elements 402 within clusters 406(b)-406(N) may be stored in a vault. The vault may be a collection of “bad” or “suspicious” data elements associated with a plurality of fraudulent transactions. The vault may be used by a score server system in real-time for online transactions to help determine transaction scores. For example, the vault may be sold to third parties and used for their decision making process. A system may use the vault to determine a transaction score and decide whether to accept, review, or reject a transaction.

For example, clusters 2-7 in FIG. 9 can be identified as fraudulent. These clusters can then be included in a vault of profiles of attackers, which can be used across various resources. When a new authentication request is received for any resource being managed by an access server, not only can the data structure specifically corresponding to that resource can be compared to the current data elements of a current authentication request, but the current data elements can also be compared to the clusters in the vault of bad profiles. If the current data elements match well (e.g., a specified number of percentage) to one or more of the bad clusters (clusters), then the request can be denied. Whether there is a consistent match can be determined using techniques described above. Such a vault may be shared among different access servers that manage different resources.

In some embodiments, the clusters in the vault may be categorized into different levels. For example, one subset of clusters can be identified as confirmed fraudulent, and thus have a certain level of fraud associated with these clusters. A match to one of these clusters can result in a higher likelihood of rejection. A different subset of clusters can be identified as potentially fraudulent, with a lower level of fraud associated with these clusters.

Accordingly, a set of other clusters of other nodes may be stored and include other data elements, the set of other clusters corresponding to a plurality of other resource identifiers and associated with the potentially fraudulent authentication requests. The one or more current data elements in the new authentication request can be compared with one or more other nodes of another cluster as part of determining whether to authorize access to the protected resource in response to the new authentication request. This comparison can also be used as part of determining whether to add the one or more new data elements as additional nodes in the new cluster in the data structure. The one or more new data elements can be added to the new cluster when the one or more new data elements match one or more other nodes of the other cluster in the set of other clusters.

### VII. EXAMPLE COMPUTER SYSTEM

Various systems may be used to implement the methods described above. An exemplary verification server is now described.

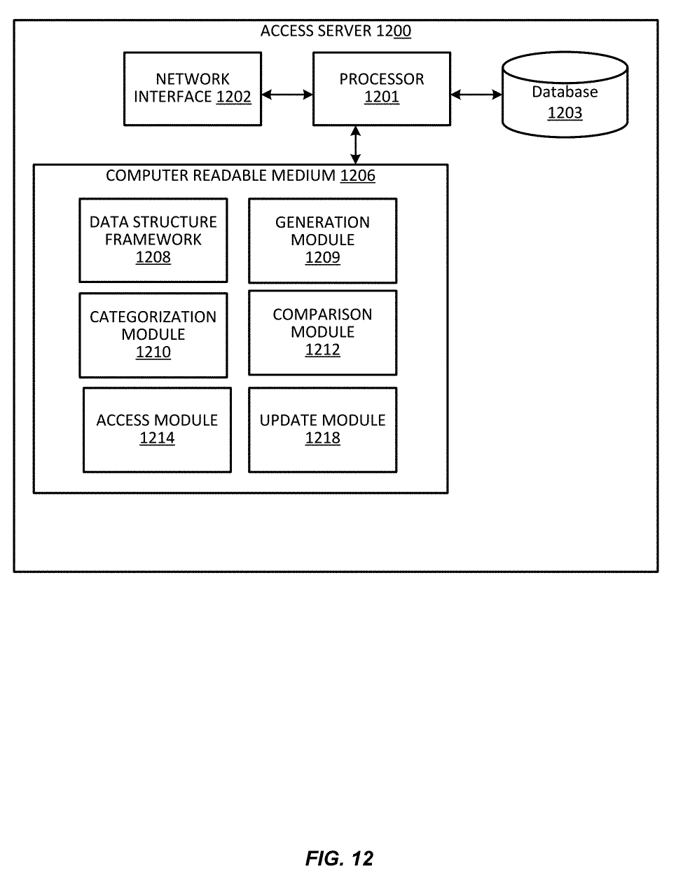

FIG. 12 shows a block diagram of an access server 1200 according to embodiments of the present invention. Access server 1200 may be used to implement access server 120 of FIG. 1 for determining whether to grant access to a protected resource, e.g., physical resource 118 or electronic resource 116. Access server 1200 may include a processor 1201 coupled to a network interface 1202 and a computer readable medium 1206.

Processor 1201 may include one or more microprocessors to execute program components for performing the functions of computer readable medium 1206, such as generation, management, and usage of data structures for determining whether to grant access to a protected resource. Network interface 1202 may be configured to connect to one or more communication networks to allow access server 1200 to communicate with other entities such as a client device operated by a user, an access device operated by a resource provider, a request computer (e.g., merchant computer), a transport computer (e.g., acquirer computer), an authorizing entity computer (e.g., issuer computer), etc. Computer readable medium 1206 may store code executable by the processor 1201 for implementing functions described herein. For example, computer readable medium 1206 may include a generation module 1209, a categorization module 1210, a comparison module 1212, and an update module 814.

A data structure framework 1208 can include any information about how a data structure is to be stored (e.g., as a linked list or table in a relational database) and which fields are to be stored, as well as in which order. Generation module 1209 can use any definitions in data structure framework 1208 to create data structures using data elements from access requests stored in a database 1203. Generation module 1209 may be used in registering a resource identifier corresponding to the protected resource.

A categorization module 1210 can categorize the nodes in the data structure into clusters as described herein. A comparison module 1212 can compare new access requests to the existing nodes of the data structure, and update module 1218 can determine whether new nodes should be added to an existing cluster or used to create a new cluster. An access module 1214 can also use results of comparison module 1212 to determine whether to grant access to a protected resource based on the data elements of the access request. If access is granted, the access server can send an authorization signal to a resource computer for granting access to the protected resource.

Any of the computer systems mentioned herein may utilize any suitable number of subsystems. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems can be interconnected via a system bus. Additional subsystems may include as a printer, keyboard, storage device(s), and monitor, which may be coupled to a display adapter. Peripherals and input/output (I/O) devices, which couple to I/O controller, can be connected to the computer system by any number of means known in the art such as input/output (I/O) port (e.g., USB, FireWire®). For example, the I/O port or external interface (e.g. Ethernet, Wi-Fi, etc.) can be used to connect computer system to a wide area network such as the Internet, a mouse input device, or a scanner. The interconnection via system bus allows the central processor to communicate with each subsystem and to control the execution of a plurality of instructions from system memory or the storage device(s) (e.g., a fixed disk, such as a hard drive, or optical disk), as well as the exchange of information between subsystems. The system memory and/or the storage device(s) may embody a computer readable medium. Another subsystem is a data collection device, such as a camera, microphone, accelerometer, and the like. Any of the data mentioned herein can be output from one component to another component and can be output to the user.

A computer system can include a plurality of the same components or subsystems, e.g., connected together by the external interface, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, units, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

What is claimed is:

1. A method comprising performing, by a computer system:
receiving a new authentication request to access a protected resource, the new authentication request comprising a resource identifier and one or more current data elements;
storing a data structure in a computer-readable medium accessible by the computer system, wherein the data structure is associated with the resource identifier and has existing nodes corresponding to existing data elements in previous authentication requests that include the resource identifier, the data structure having connections indicating which existing nodes have occurred in a same previous authentication request;
comparing the one or more current data elements in the new authentication request with the existing nodes in the data structure, wherein the existing nodes are stored in the data structure in one or more clusters based on a commonality of the connections among the existing nodes; and
responsive to the comparing, identifying one or more new data elements of the one or more current data elements that do not match one of the existing nodes of the data structure;
adding the one or more new data elements as one or more additional nodes in the data structure, wherein
(1) the one or more additional nodes are stored in an existing cluster responsive to an amount of the one or more current data element that match existing nodes of the existing cluster, the existing cluster representing a pattern of legitimate authentication requests, or
(2) the one or more additional nodes are stored in a new cluster in the data structure, the new cluster in the data structure representing a pattern of potentially fraudulent authentication requests, wherein the data structure is used to determine whether to authorize access to the protected resource in response to the new authentication request.

2. The method of claim 1, further comprising performing, by the computer system:
registering the resource identifier for the protected resource;
receiving one or more initial data elements as part of registering the resource identifier; and
generating the existing cluster of the data structure to include one or more nodes corresponding to the one or more initial data elements.

3. The method of claim 1, further comprising performing, by the computer system:
receiving, from an administrator of the protected resource, an indication that one or more authentication requests associated with the new cluster are fraudulent; and
identifying the new cluster as a fraudulent cluster associated with an intruder to the protected resource.

4. The method of claim 1, further comprising performing, by the computer system:
determining whether to authorize access to the protected resource in response to the new authentication request based on the comparing of the one or more current data elements in the new authentication request with the existing nodes in the data structure.

5. The method of claim 4, further comprising performing, by the computer system:
sending an authorization signal to a resource computer for granting access to the protected resource in response to determining that access is to be granted.

6. The method of claim 4, further comprising performing, by the computer system:
storing a set of other clusters of other nodes that include other data elements, the set of other clusters corresponding to a plurality of other resource identifiers and associated with the potentially fraudulent authentication requests; and
comparing the one or more current data elements in the new authentication request with one or more other nodes of another cluster as part of determining whether to authorize access to the protected resource in response to the new authentication request.

7. The method of claim 6, wherein the set of other clusters of other nodes are categorized into clusters that are confirmed fraudulent and into clusters that are potentially fraudulent.

8. The method of claim 4, wherein determining whether to authorize access to the protected resource includes:
determining a matching amount of the one or more current data elements that match the existing nodes of the existing cluster; and
comparing the matching amount to a threshold.

9. The method of claim 8, wherein the matching amount is:
a number of the one or more current data elements that match the existing nodes of the existing cluster,
a percentage of the one or more current data elements that match the existing nodes of the existing cluster, or
a score determined based on a respective weighted assigned to each matching data element.

10. The method of claim 8, further comprising:
granting access to the protected resource based on the amount exceeding the threshold.

11. The method of claim 1, further comprising performing, by the computer system:
storing a set of other clusters of other nodes that include other data elements, the set of other clusters corresponding to a plurality of other resource identifiers and associated with the potentially fraudulent authentication requests; and
comparing the one or more current data elements in the new authentication request with one or more other nodes of another cluster in the set of other clusters as part of determining whether to add the one or more new data elements as additional nodes in the new cluster in the data structure, wherein the one or more new data elements are added to the new cluster when the one or more new data elements match one or more other nodes of the other cluster in the set of other clusters.

12. The method of claim 1, further comprising performing, by the computer system:
receiving a timestamp for each of a plurality of authentication requests;
identifying which of a plurality of clusters each of the authentication requests corresponds; and
displaying a timeline graph having a time axis, wherein the timeline graph includes each of the plurality of clusters with each of its authentication requests displayed at a time corresponding to the timestamp, wherein each cluster is displayed with an indication of whether the cluster is legitimate.

13. The method of claim 1, further comprising performing, by the computer system:
displaying the nodes of the data structure with lines indicating the connections among nodes, wherein each cluster of nodes is displayed separated from other clusters of the data structure.

14. The method of claim 1, wherein the one or more current data elements and the existing data elements include at least one selected from: a name, an email address, a device fingerprint, an IP address, and a phone number.

15. The method of claim 1, wherein the resource identifier includes at least one selected from: username, a device fingerprint, and an email.

16. A computer system, comprising:
a computer readable medium storing a plurality of instructions; and
one or more processors configured to execute the instructions stored on the computer readable medium to perform:
receiving a new authentication request to access a protected resource, the new authentication request comprising a resource identifier and one or more current data elements;
storing a data structure in a computer-readable medium accessible by the computer system, wherein the data structure is associated with the resource identifier and has existing nodes corresponding to existing data elements in previous authentication requests that include the resource identifier, the data structure having connections indicating which existing nodes have occurred in a same previous authentication request;
comparing the one or more current data elements in the new authentication request with the existing nodes in the data structure, wherein the existing nodes are stored in the data structure in one or more clusters based on a commonality of the connections among the existing nodes; and
responsive to the comparing, identifying one or more new data elements of the one or more current data elements that do not match one of the existing nodes of the data structure;
adding the one or more new data elements as one or more additional nodes in the data structure, wherein
(1) the one or more additional nodes are stored in an existing cluster responsive to an amount of the one or more current data element that match existing nodes of the existing cluster, the existing cluster representing a pattern of legitimate authentication requests, or
(2) the one or more additional nodes are stored in a new cluster in the data structure, the new cluster in the data structure representing a pattern of potentially fraudulent authentication requests, wherein the data structure is used to determine whether to authorize access to the protected resource in response to the new authentication request.

17. The computer system of claim 16, wherein the one or more processors are configured to execute the instructions stored on the computer readable medium to further perform:
registering the resource identifier for the protected resource;
receiving one or more initial data elements as part of registering the resource identifier; and
generating the existing cluster of the data structure to include one or more nodes corresponding to the one or more initial data elements.

18. The computer system of claim 16, wherein the one or more processors are configured to execute the instructions stored on the computer readable medium to further perform:
determining whether to authorize access to the protected resource in response to the new authentication request based on the comparing of the one or more current data elements in the new authentication request with the existing nodes in the data structure.

19. The computer system of claim 16, wherein the one or more processors are configured to execute the instructions stored on the computer readable medium to further perform:
storing a set of other clusters of other nodes that include other data elements, the set of other clusters corresponding to a plurality of other resource identifiers and associated with the potentially fraudulent authentication requests; and
comparing the one or more current data elements in the new authentication request with one or more other nodes of another cluster in the set of other clusters as part of determining whether to add the one or more new data elements as additional nodes in the new cluster in the data structure, wherein the one or more new data elements are added to the new cluster when the one or more new data elements match one or more other nodes of the other cluster in the set of other clusters.

20. The computer system of claim 16, wherein the one or more processors are configured to execute the instructions stored on the computer readable medium to further perform:
receiving a timestamp for each of a plurality of authentication requests;
identifying which of a plurality of clusters each of the authentication requests corresponds;
displaying a timeline graph having a time axis, wherein the timeline graph includes each of the plurality of clusters with each of its authentication requests displayed at a time corresponding to the timestamp, wherein each cluster is displayed with an indication of whether the cluster is legitimate; and
displaying the nodes of the data structure with lines indicating the connections among nodes, wherein each cluster of nodes is displayed separated from other clusters of the data structure.
